(19) United States
(12) Patent Application Publication
(10) Pub. No.: US 2015/0047797 A1
(43) Pub. Date: Feb. 19, 2015

(54) METHOD AND APPARATUS FOR PROTECTING FLEXIBLE WINDOWS

(71) Applicant: FRANK MICHAEL WEYER, LOS ANGELES, CA (US)

(72) Inventor: FRANK MICHAEL WEYER, LOS ANGELES, CA (US)

(21) Appl. No.: 13/969,285

(22) Filed: Aug. 16, 2013

(51) Int. Cl. B60J 1/20; B60J 11/08

(52) U.S. Cl. CPC B60J 1/2094; B60J 11/08
USPC 160/370.21

(57) ABSTRACT

The present invention comprises a removable protective shield for windows that protects the windows yet does not impede the operation of the item in which the window is incorporated and does not mar or physically alter the window or item in which the window is incorporated. In one or more embodiments, the protective shield of the present invention comprises a piece of transparent or translucent rigid or semi-rigid plastic sheet sized and shaped so as to extend at least partially beyond the perimeter of the window which is intended to be protected. The protective shield of the invention may, for example, comprise a transparent or translucent acrylic or polycarbonate sheet. Removable, non-marring attachment mechanisms are used to attach the protective shield to the item in which the window is incorporated such that that item (i.e. convertible top or dodger) is not altered or damaged.

### FIELD OF THE INVENTION

The present invention relates to the field of flexible windows, including those used in convertible automobile tops and dodgers used on boats and other vessels, and specifically to a method and apparatus for protecting such flexible windows from damage and degradation.

### BACKGROUND OF THE INVENTION

Flexible windows, often made of a transparent plastic material, are often included as rear windows in convertible automobile tops and as windows for dodgers for sailing boats and other vessels. Flexible windows are used because the tops/dodgers are designed to be folded (e.g. when lowered, removed, or stored) in a manner such that rigid glass windows cannot be used. Flexible windows, however, are easily damaged and over time visually degrade due exposure to sunlight and the environment and other reasons. As a result, convertible tops for cars and dodgers for boats often need to be replaced due to the degradation of the flexible windows, even though the tops and dodgers overall are still in operational condition. There is a need for a device that protects flexible windows from degradation, but that does not impede the operation of or mar or alter a convertible roof, dodger, or other item in which the flexible window is placed.

### SUMMARY OF THE INVENTION

The present invention comprises a removable protective shield for windows that protects the windows yet does not impede the operation of the item in which the window is incorporated and does not mar or physically alter the window or item in which the window is incorporated. In one or more embodiments, the protective shield of the present invention comprises a piece of transparent or translucent rigid or semi-rigid plastic sheet sized and shaped so as to extend at least partially beyond the perimeter of the window which is intended to be protected. The protective shield of the invention may, for example, comprise a transparent or translucent acrylic or polycarbonate sheet. In one or more embodiments, the sheet has a thickness of between 1/16 and ¼ inches, although any desired thickness can be used. Removable, non-marring attachment mechanisms are used to attach the protective shield to the item in which the window is incorporated such that that item (i.e. convertible top or dodger) is not altered or damaged. In one or more embodiments, one or more magnets, such as rare earth magnets, are attached to the protective shield at portions of the shield that extend beyond the perimeter of the window to be protected when the shield is mounted. To fasten the shield to the item in which the window is installed, a clamping member, such as a mating magnet, is placed on the other side of the item in which the window is installed adjacent to the magnet that is attached to the shield, holding the magnet, and therefore the shield, in place, in a non-marring manner that does not require any physical changes to the item in which the window is installed. In other embodiments, other removable, non-intrusive (i.e. that do not change the structure or damage the item in which the window is mounted or the window itself) fastening mechanisms are used, including suction cups that adhere to the exterior surface of the window itself.

### BRIEF DESCRIPTION OF THE DRAWINGS

FIG. 1 is a plan view of an embodiment of a protective shield of the invention.

FIG. 2 is detail side view of a magnet assembly of a protective shield of the invention.

FIG. 3 is perspective exterior view of an embodiment of the protective shield of the invention attached to a convertible top.

FIG. 4 is perspective interior view of an embodiment of the protective shield of the invention attached to a convertible top.

FIG. 5 is a detail front view of the magnet assembly of an embodiment of the protective shield of the invention.

FIG. 6 is a detail rear view of the magnet assembly of an embodiment of the protective shield of the invention.

FIG. 7 is a side view of a stack of a plurality of magnets of the type used in one or more embodiments of the protective shield of the invention.

FIG. 8 is a cross sectional drawing showing how the protective shield of the invention is fastened to a convertible top in one or more embodiments of the invention.

FIG. 9 is a flow chart illustrating steps of a method of attaching a protective shield of one or more embodiments of the present invention.

### DETAILED DESCRIPTION OF THE INVENTION

In the following description, numerous specific details are set forth to provide a thorough description of the invention. However, it will be apparent to those of ordinary skill in the art that the invention may be practiced without these specific details. In other instances, well-known features have not been described in detail so as not to obscure the invention.

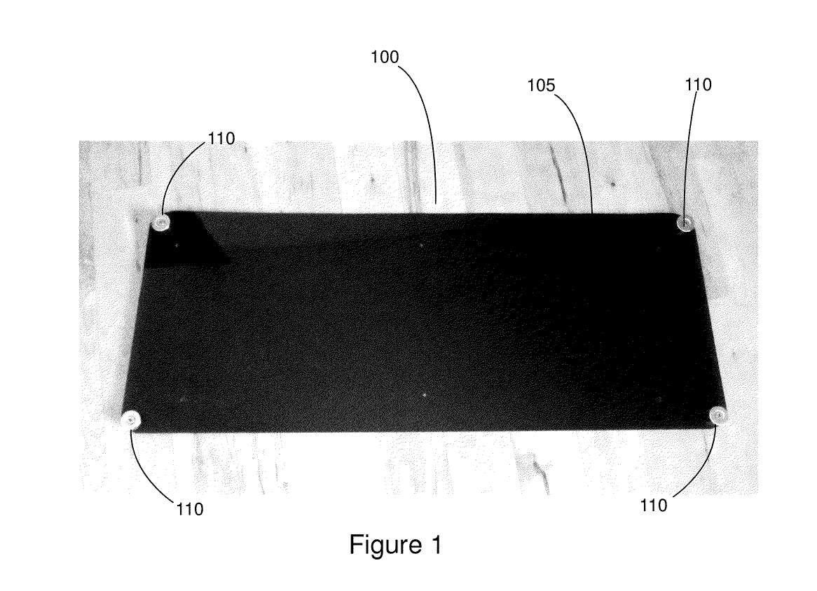

FIG. 1 shows a plan view of a protective shield 100 of the invention. In the embodiment of FIG. 1, protective shield 100 comprises an acrylic or polycarbonate plastic sheet 105 to which a plurality of magnet assemblies 110 have been mounted. In the embodiment of FIG. 1 sheet 105 comprises a translucent sheet preferably ⅛″ to ¼″ in thickness having a smoke color (which gives the appearance of a tinted window and helps reduce the amount of sunlight transmitted by protective shield 100) and a generally rectangular shape with rounded corners. However, sheet 105 can be clear or translucent or fully or partially opaque in any desired shade, have any shape, and any desired thickness. In the embodiment of FIG. 1, four magnet assemblies 110 have been mounted adjacent the corners of sheet 105. However, greater or lesser numbers of magnet assemblies 110 may be used, and they may be mounted to sheet 105 at other locations.

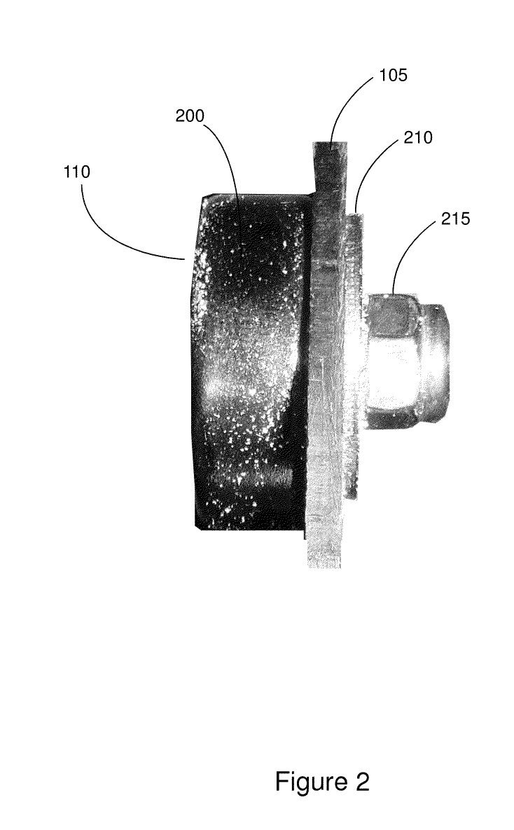

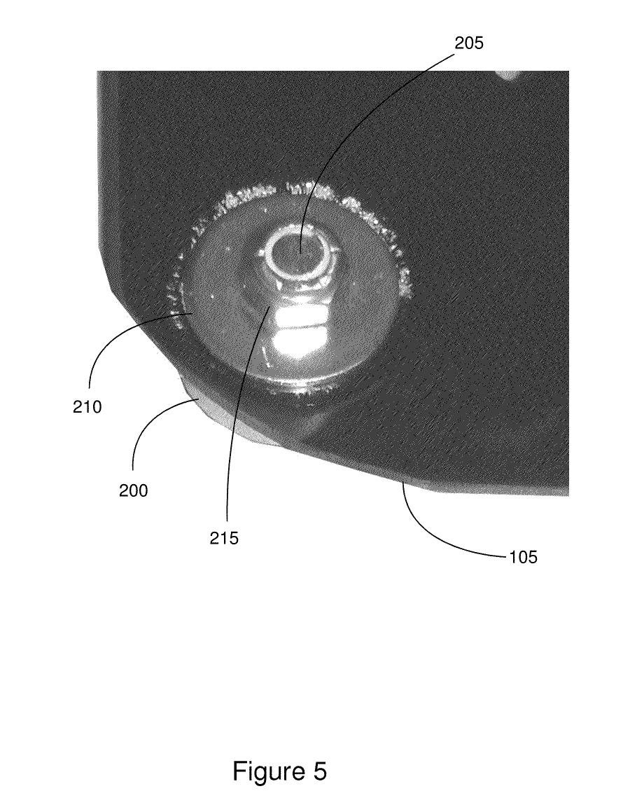

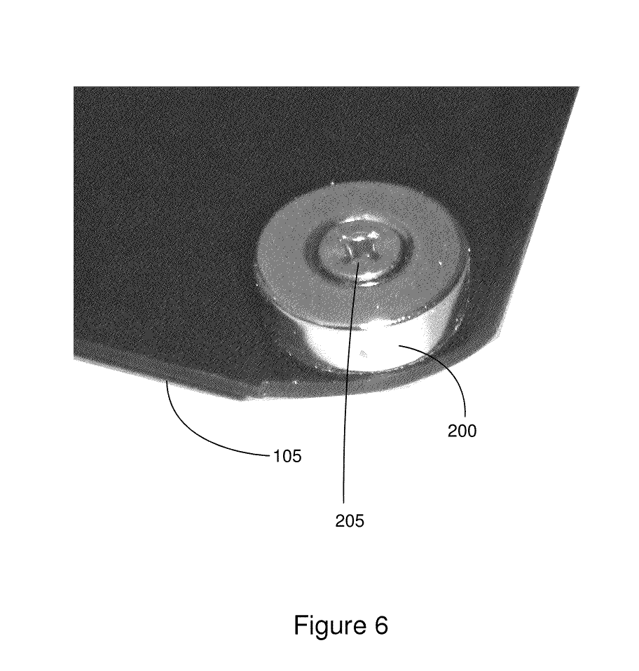

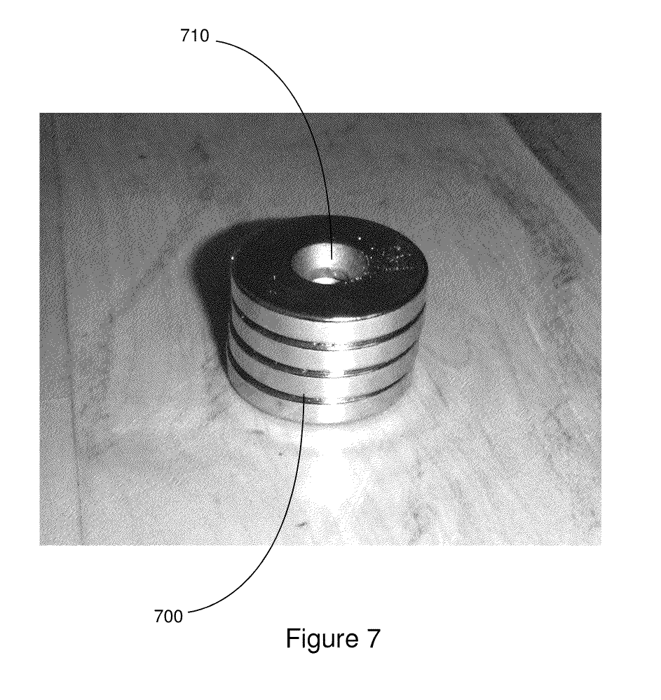

FIGS. 2, 5 and 6 show detailed views of a magnet assembly 110 of one or more embodiments of the invention. In the embodiment of FIGS. 2, 5 and 6, magnet assembly comprises a disk shaped magnet 200 featuring a countersunk central mounting hole (710 in FIG. 7) fastened to one side of sheet 105 using a flat topped screw 205 (shown in FIG. 6) inserted through a matching hole in sheet 105 and secured with fender washer 210 and locknut 215. In one or more embodiments magnet 200 is a rare earth magnet approximately an inch in diameter and ¼ inch thick. FIG. 7 shows a stack 700 of four magnets 200. Magnets 200 are preferably magnetically polarized such that one side is N and the other S, such that there is a strong magnetic attraction between magnets arranged with the N side of one magnet adjacent to the S side of the other, as in stack 700 of FIG. 7. Other sizes, shapes, and types of magnets may be used, including electric magnets. In one or more embodiments screw 205 has a ¼ inch diameter thread. Other types and sizes of fasteners may be used to fasten magnet 200 to sheet 105, or magnet 200 may be glued to or otherwise fastened to sheet 200 using fastening methods known to those of skill in the art.

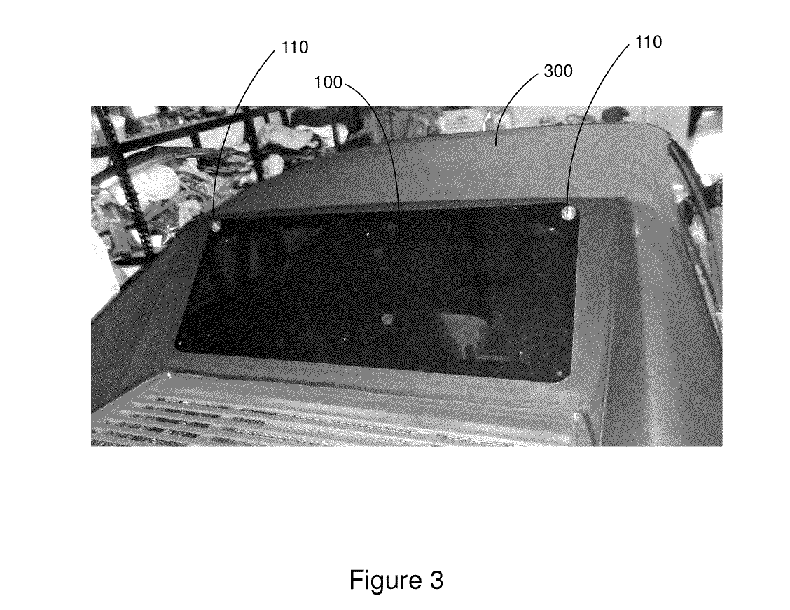

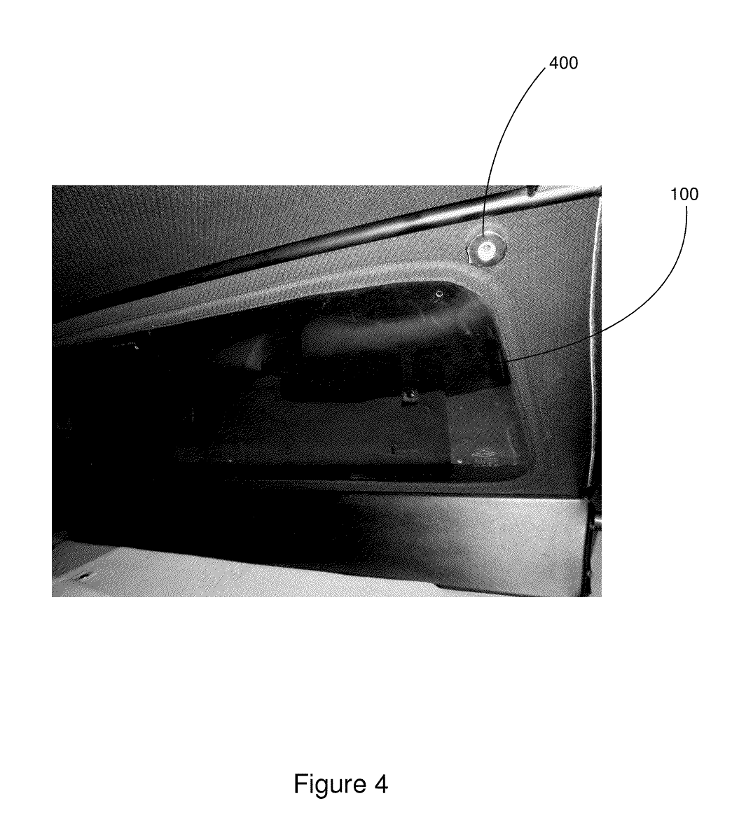

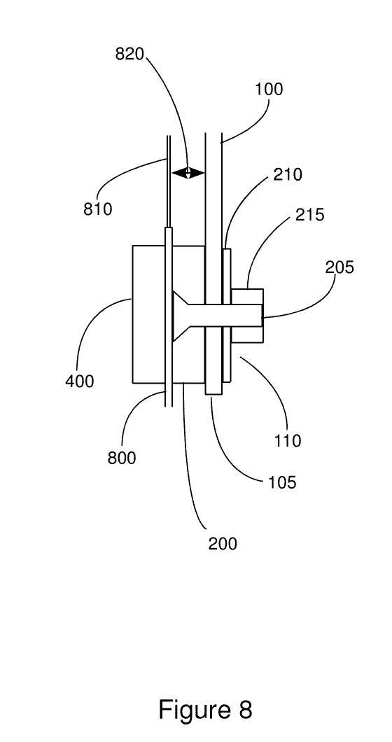

FIGS. 3 and 4 show how an embodiment of the protective shield 100 of the invention is attached to a convertible top 300 so as to protect the convertible top's rear window. In the embodiment of FIG. 3, protective shield comprises two magnet assemblies 110 attached to protective shield 100 at the upper left and right corners. In the embodiment of FIG. 3, protective shield 100 is positioned adjacent to the rear window of convertible top 300 such that the magnet sides of magnet assemblies 110 are positioned against the convertible top material (which may be cloth, canvas, vinyl or any other material) adjacent to the rear window (shield 100 is sized so that it extends beyond the perimeter of the window and overlaps the convertible top material). As shown in FIG. 4, a clamping member 400 is placed against the inside of the convertible top material directly opposite where a magnet assembly 110 is positioned on the outside of the convertible top material. Clamping member 400 may be a magnet identical or similar to magnet 200 of magnet assembly 110, or a may be smaller, larger, of a different material, may be of greater or lesser magnetic strength, or may be unmagnetized magnetic material, such as steel (e.g. a steel disk or washer), depending on the type and thickness of the convertible top material, the number of magnet assemblies used, and the force necessary to hold protective shield 100 in place. As shown in FIG. 8, the result is a sandwich like structure in which the magnetic forces of clamping member 400 and magnet 200 of magnet assembly 110 clamp the convertible top material 800 between them, holding protective shield 100 in place adjacent to rear window 810 of convertible top 300. In the embodiment of FIG. 8, the thickness of magnet 200 provides a gap 820 between protective shield 100 and rear window 810, such that protective shield 100 is spaced apart from and does not contact rear window 810.

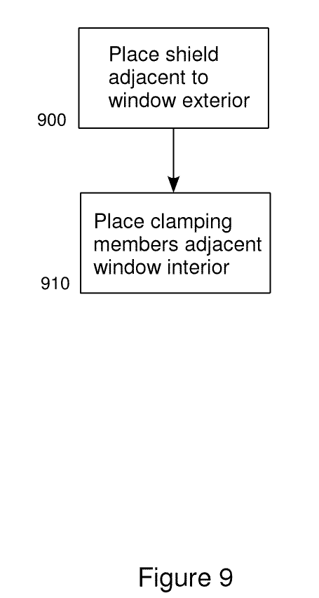

FIG. 9 shows the method steps used in one or more embodiments to attach protective shield 100 adjacent to a window in one or more embodiments of the invention. At step 900, a protective shield of the invention comprising a plurality of magnetic mounting assemblies is positioned adjacent to the exterior side of a window to be protected such that the mounting assemblies extend beyond the perimeter of the window. At step 910, clamping members, which may, for example, comprise magnets or other magnetic material, are placed on the opposite side of the material in which the window is mounted adjacent to the mounting assemblies so as to clamp the material in which the window is mounted between the clamping members and the magnetic mounting assemblies in a removable and non-marring manner.

Fastening systems other than or in addition to magnet assembly 110 and clamping member 400 may be used to removably mount protective shield 100 adjacent to the window that is being overlaid with protective shield 100. For example, suction cups may be attached to protective shield 100 that are configured to engage a flat surface, such as the rear window itself.

Thus, a novel protective shield for windows, such as those incorporated in convertible automobile tops and boat dodgers, has been presented. Although the invention has been described using specific example embodiments, those of ordinary skill in the art will understand that the invention is not limited to the specific example embodiments described herein. For example, the protective shield of the invention can be used to protect or to enhance the appearance of rigid as well as flexible windows, and may be used to provide removable smoke tinting to clear glass windows in cars and other vehicles and vessels. Other embodiments will be apparent to those skilled in the art.

1. A method for protecting a window mounted in a first material comprising the steps of:
placing a flat planar translucent protective sheet comprising a plurality of magnetic mounting assemblies each comprising a first magnet having a first thickness adjacent to said window such that said mounting assemblies are positioned adjacent to said first material beyond a perimeter of said window on an exterior of said first material and such that said mounting assemblies maintain said protective sheet spaced apart from said window by a gap formed said first thickness of said magnets of said magnetic mounting assemblies;
placing magnetic clamping members each comprising a second magnet adjacent to said magnetic mounting assemblies on an inside of said first material so as to hold said protective sheet in place adjacent to but spaced apart by said gap from said window.

2. A protective shield for a window having a first perimeter mounted in a first material comprising:
an entirely flat planar translucent sheet having a second perimeter that is greater than said first perimeter such that said planar translucent overlaps said window when placed over said window such that an overlap region is defined between said first perimeter of said window and said second perimeter of said planar translucent sheet, said planar translucent sheet having a first thickness and first and second parallel planar surfaces;
a plurality of first magnets secured to said first planar surface of said planar translucent sheet within said overlap region, said first magnets extending from said first planar surface by a second thickness of said first magnets;
a plurality of second magnets configured to be removably magnetically secured to said plurality of first magnets and to clamp said first material between each of said plurality of first magnets and a corresponding of said plurality of second magnets, said plurality of first magnets configured to maintain said planar translucent sheet spaced apart from said window by said second thickness and to prevent contact between said window and said planar translucent sheet.

3. The protective shield of claim 2 wherein said first magnets are secured to said translucent planar sheet with mechanical fasteners.

4. The protective shield of claim 3 wherein said first magnets comprise countersunk mounting holes and said mechanical fasteners comprise flat head screws disposed in said mounting holes.

5. The protective shield of claim 1 wherein said second thickness is approximately ¼ inch.

6. The protective shield of claim 5 wherein said first thickness of said planar translucent sheet is ⅛ inch to ¼ inch.

7. The protective shield of claim 1 wherein said protective shield comprises a smoke color and is configured to provide removable smoke tinting to a window of a vehicle.

8. A method for providing removable smoke tinting to a window comprising the steps of:
placing a flat, entirely planar tinted translucent sheet comprising a plurality of magnetic mounting assemblies each comprising a first magnet having a first thickness adjacent to said window such that said mounting assemblies maintain said planar tinted translucent sheet spaced apart from said window by a gap formed said first thickness of said magnets of said magnetic mounting assemblies;
placing magnetic clamping members each comprising a second magnet adjacent to said magnetic mounting assemblies so as to hold said planar translucent tinted sheet in place adjacent to but spaced apart by said gap from said window.
